(19) United States
(12) Patent Application Publication
(10) Pub. No.: US 2004/0224116 A1
(43) Pub. Date: Nov. 11, 2004

(54) Roll of absorbent paper towels with adhesive strips and method for manufacturing

(76) Inventor: Norman P. Manasa, Washington, DC (US)

Correspondence Address: BIRCH STEWART KOLASCH & BIRCH, PO BOX 747, FALLS CHURCH, VA, 22040-0747, US

(21) Appl. No.: 10/834,911

(22) Filed: Apr. 30, 2004

Related U.S. Application Data
(60) Provisional application No. 60/468,100, filed on May 6, 2003.

(51) Int. Cl. B32B 9/00

(52) U.S. Cl. 428/40.1; 428/43; 428/906

(57) ABSTRACT

A roll of absorbent paper towels including perforated tear lines provided at predetermined intervals along a length thereof to form rectangular sheets between each perforated tear line. Each sheet is provided with at least one adhesive strip on the centerline of the paper. The paper is folded along a longitudinal centerline of the paper, thus causing opposite halves of the adhesive strip to face each other between two halves of the folded paper. Adhesive strips may be provided in various positions on each sheet, so long as exposed portions face each other when the paper is folded. Non-adhesive borders can be provided around one or more of the adhesive strips to facilitate separation during unfolding of the sheets. The method of manufacturing a paper towel having adhesive strips on each sheet of paper includes rolling the folded paper onto a spindle after the paper is folded along the longitudinal centerline.

### CROSS-REFERENCE TO RELATED APPLICATION

The present application claims priority to Provisional Application No. 60/468,100, filed May 6, 2003, the entire contents of which are hereby incorporated by reference.

### BACKGROUND OF THE INVENTION

1. Field of the Invention

The present invention relates to a roll of absorbent paper towels, with each section of towel being provided with at least one adhesive strip, and a method for manufacturing rolls of paper towels with adhesive strips.

2. Description of Background Art

Conventionally, absorbent paper towels are manufactured as a long length of paper having 50 to 100 or more rectangular sections or sheets connected by perforated tear lines. Typically, the paper is packaged for sale and use in a roll form. The perforated tear lines between the rectangular sections run perpendicular to the length of the paper and parallel to the length of the roll. During use, one or more rectangular sections, or sheets, are torn off. The paper sheet or sheet(s) can then be used for a variety of purposes.

However, since the individual sheets are lightweight, problems may occur when they are used. For example, when used on a horizontal surface, the sheets may move or blow away when subject to very light air motion. Further, if it is desired to use the paper sheets on a slanted or vertical surface, there is no means by which to adhere the sheets. Thus, the use for conventional paper towels is limited.

### SUMMARY AND OBJECT OF THE INVENTION

One object of the present invention is to solve the above-mentioned problems, by providing each sheet of rolled paper with at least one adhesive strip enabling the user to adhere individual sheets to most any surface regardless of the orientation of the surface. Another object of the present invention is to provide a method of manufacturing rolled paper towels having adhesive strips on each sheet.

According to a first aspect of the present invention, a roll of paper towels includes a length of paper having a predetermined length and width. The paper includes a plurality of perforated tear lines formed at predetermined intervals and running perpendicular to the length and between two edges of the paper; a plurality of rectangular sheets being formed between the perforated tear lines; at least one adhesive strip provided on one surface of each of the rectangular sheets; a fold formed along a longitudinal centerline of the paper, the edges of the paper being folded together enclosing the at least one adhesive strip and forming a folded paper having double thickness and a width one half of the width of the paper prior to folding, the folded paper being rolled on a spindle, wherein, upon unrolling of the folded paper, each of the plurality of sheets is separable along the perforated tear lines from an adjoining one of the plurality of rectangular sheets, and capable of being unfolded to expose the at least one adhesive strip.

With this novel rolled paper towel, folding the paper along a longitudinal centerline encloses and protects the adhesive strip(s) that is affixed to each of the adjoining sheets. When a sheet is torn off from an adjoining sheet, and unfolded to expose the adhesive strip, the adhesive strip enables the unfolded sheet to readily adhere to and be released from most any smooth or rough surface.

According to a second aspect of the present invention, a roll of paper towels includes a plurality of perforated tear lines formed at predetermined intervals and running perpendicular to the length and between two edges of the paper; a plurality of rectangular sheets being formed between the perforated tear lines; at least one adhesive strip provided on one surface of each of the rectangular sheets, and at least one non-adhesive strip provided on an opposite surface of each of the rectangular sheets; the paper being rolled on a spindle so that the at least one adhesive strip on each of the rectangular sheets faces the at least one non-adhesive strip provided on the opposite surface of the adjoining rectangular sheet, wherein, upon unrolling of the paper, each of the plurality of sheets is separable along the perforated tear lines from the adjoining one of the plurality of rectangular sheets, thereby exposing the at least one adhesive strip.

With this novel rolled paper towel the adhesive strip(s) on each sheet face and are protected by non-adhesive strip(s) that are affixed to each of the adjoining sheets. When a sheet is torn off from an adjoining sheet, and the adhesive strip is released from the non-adhesive strip on the adjoining sheet, the adhesive strip is exposed which enables the sheet to readily adhere to and be released from most any smooth or rough surface.

Further according to a third aspect of the present invention, a method of manufacturing a roll of paper towels with sheets having adhesive strips includes the steps of providing a paper with a predetermined width; forming a plurality of perforated tear lines at predetermined intervals and running perpendicular to the length and between two edges of the paper, thereby forming rectangular sheets between each of the perforated tear lines; providing at least one adhesive strip on one surface of each of the rectangular sheets; folding the paper along a longitudinal centerline of the paper, the edges of the paper being folded together enclosing the at least one adhesive strip and forming a folded paper and folded rectangular sheets having double thicknesses and widths that are one half of the widths prior to folding; and rolling the folded paper, and the folded rectangular sheets formed thereon, onto a spindle.

According to a fourth aspect of the present invention, a method of manufacturing a roll of paper towels with sheets having adhesive strips includes the steps of providing a paper having a predetermined length and width; forming a plurality of perforated tear lines at predetermined intervals and running perpendicular to the length and between two edges of the paper, thereby forming a rectangular sheet between each of the perforated tear lines; providing at least one adhesive strip on one surface of each of the rectangular sheets; providing at least one non-adhesive strip provided on an opposite surface of each of the rectangular sheets; rolling the paper on a spindle so that the at least one adhesive strip on each of the rectangular sheets faces the at least one non-adhesive strip provided on the opposite surface of the adjoining rectangular sheet, wherein, upon unrolling of the paper, each of the plurality of sheets is separable along the perforated tear lines from the adjoining one of the plurality of rectangular sheets, thereby exposing the at least one adhesive strip.

Each of the methods of manufacturing a rolled paper towel of the present invention described above provides an effective process for producing rolled paper towel having adhesive strips, in such a manner that the adhesive strips on each sheet are not exposed to the outside until ready for use.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIGS. 1(a) and (b) show unfolded and folded views respectfully of the first embodiment of the present invention with adhesive strips provided on the centerline of the paper;

FIG. 2 shows a second embodiment of the present invention, with a non-adhesive border provided around the adhesive strip;

FIG. 3 shows a third embodiment of the present invention, with four adhesive strips provided on each sheet;

FIGS. 4(a) and (b) show a fourth embodiment of the present invention, in which the paper is not folded, and an adhesive strip is provided on one surface and a non-adhesive strip is provided in a corresponding position on the opposite surface of each sheet;

FIGS. 5(a) and (b) show another embodiment of the present invention, in which the paper is formed with multiple layers;

FIG. 6 is a schematic diagram of one manufacturing operation of the present invention;

FIG. 7 shows a flow chart of the steps in one manufacturing method of the present invention;

FIG. 8(a) shows still another embodiment of the present invention in which the length of paper is encased in a non-porous sleeve, and FIG. 8(b) shows a second manufacturing method of the present invention; and

FIG. 9 shows a flow chart of the steps in a third manufacturing method of the present invention.

### DETAILED DESCRIPTION OF THE PREFERRED EMBODIMENTS

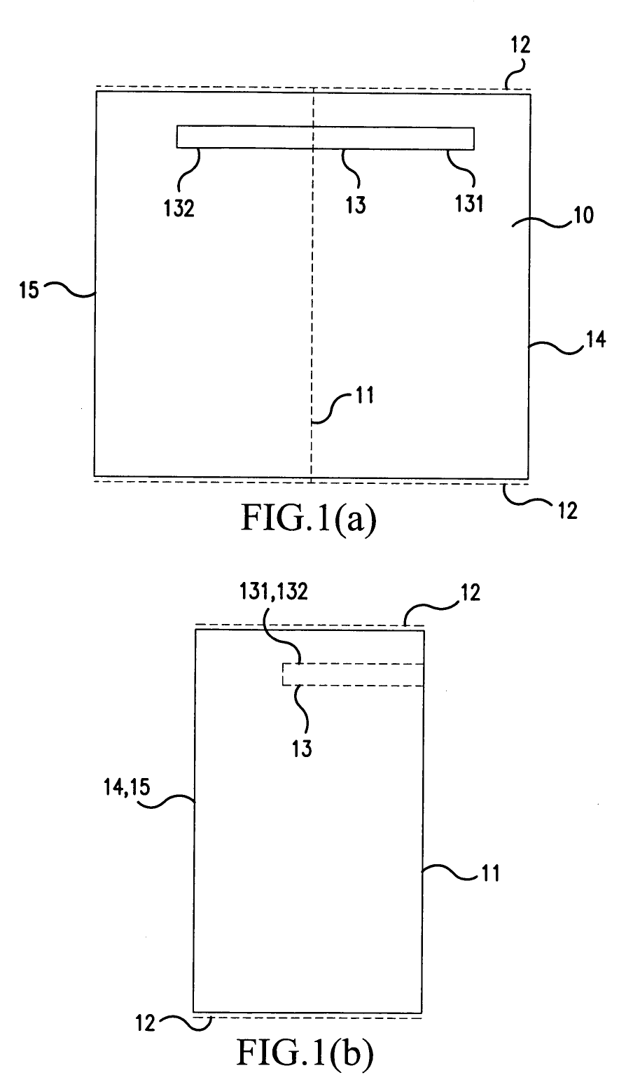

The first embodiment will be described with reference to FIGS. 1(a) and (b), which show a single rectangular sheet 10. Typically, sheet 10 is approximately 11″ wide. Sheets 10 may be either reusable sheets or non-reusable sheets. FIG. 1(a) shows sheet 10 unfolded, and FIG. 1(b) shows sheet 10 folded along the longitudinal centerline 11. Perforated tear lines 12, 12 are at the top edge and lower edge of each sheet. Adhesive strip 13 is approximately 8″×½″, and is centered on the centerline 11, so that the right and left halves 131, 132 of strip 13 exactly face each other in the folded state. Typically, adhesive strips 13 are affixed to only one side of sheet 10. Also shown in FIGS. 1(a) and (b) are right and left edges 14, 15 of sheet 10.

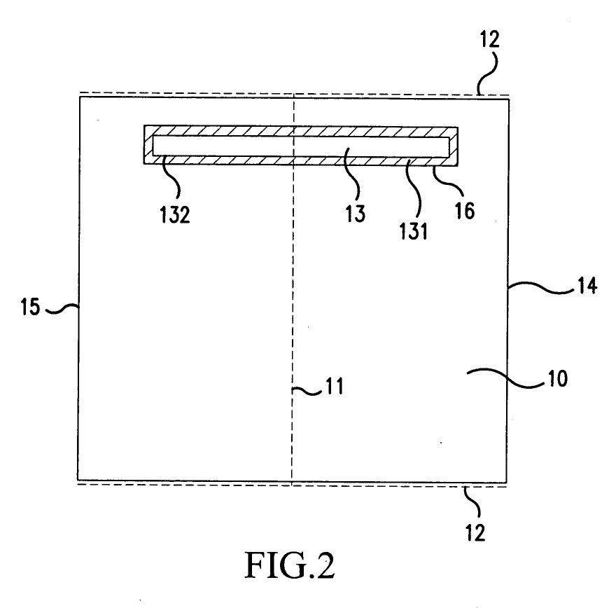

FIG. 2 depicts a second embodiment of the present invention, with the adhesive strip 13 surrounded by a non-adhesive border 16. As in the first embodiment, adhesive strip 13 is approximately 8″×½″ and is centered on the centerline 11, so that the right and left halves 131, 132 of strip 13 exactly face each other in the folded state. During unfolding of the sheet 10, the non-adhesive border 16 facilitates separating the two halves 131, 132 of the adhesive strip 13.

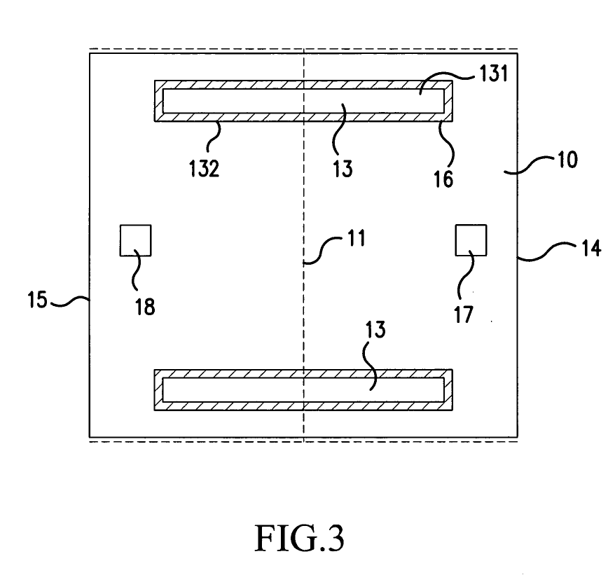

FIG. 3 shows a third embodiment of the present invention, with two adhesive strips 13 being provided on the centerline 11, and two additional adhesive strips 17, 18 provided, respectively, adjacent to the right and left edges 14, 15 of each sheet 10. When folded, the right and left halves 131, 132 of adhesive strips 13 exactly face each other. Similarly, adhesive strips 17, 18 exactly face each other when the sheet 10 is in the folded state. One or more of strips 13, 17, and 18 may be provided with non-adhesive borders 16.

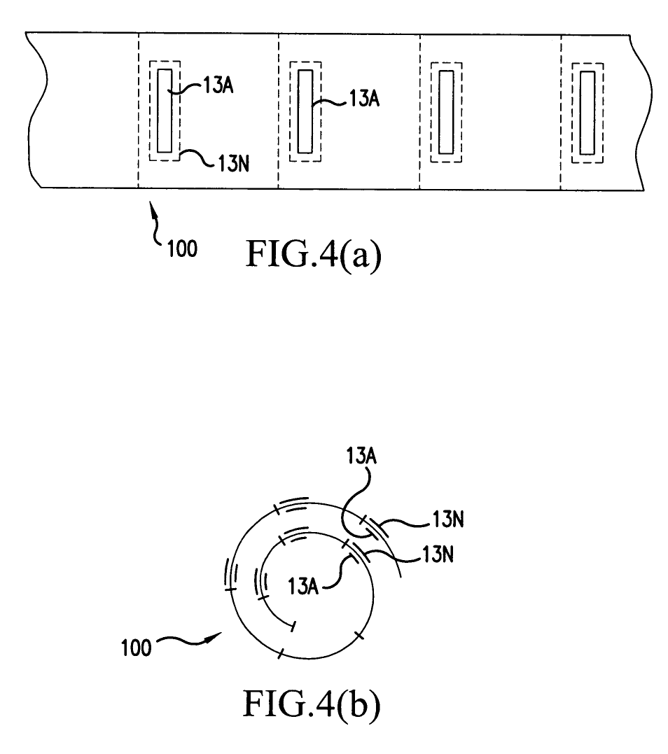

FIGS. 4(a) and (b) show a fourth embodiment of the present invention, in which the paper 100 in not folded in a longitudinal direction. Instead, a spindle having the same width as the width of the paper is provided and the roll is simply rolled onto the spindle. Each of the sheets is provided with at least one adhesive strip 13A on one surface and a non-adhesive strip 13N on the opposite surface of the sheet.

With the fourth embodiment, the first paper sheet pulled off the roll by the user (called sheet #100 in this example) will have an adhesive strip 13A placed on the its underside, and this strip will rest precisely on a corresponding non-adhesive strip 13N affixed to the second sheet on the roll (sheet #99).

The non-adhesive strip would be slightly larger in length and width than the corresponding adhesive strip. For example, if the adhesive strip 13A is 8″×½″ in size, then the non-adhesive strip 13N might be 8½″×1″ in size.

The second sheet on the roll (sheet #99), in addition to having a non-adhesive strip 13N on the top-side of the sheet, will also have an adhesive strip 13A on its underside, and this adhesive strip 13A will rest precisely on a corresponding non-adhesive strip 13N on the third sheet on the roll (sheet #98).

This process will be repeated for all 100 paper sheets on the roll, so that each of the sheets will have both (1) a non-adhesive strip 13N on the top-side of the sheet and (2) an adhesive strip 13A on the underside of the sheet. It is also possible for the first sheet (the outermost sheet #100 on the roll) to be formed without a non-adhesive strip 13N if desired.

As a result, when the user separates one sheet from the roll, the sheet will already be 11″ wide, and (unlike the sheets produced by the first manufacturing process) will not need to be unfolded by the user (saving the user one step), since the strip of adhesive will already be fully exposed. In general, the adhesive strip 13A will be placed on every sheet at the same uniform distance below the horizontal perforation, for example, ¼″ below the perforation on each sheet on the roll. Each non-adhesive strip 13N, however, will be placed on the sheet so as to meet its corresponding adhesive strip 13A from the sheet above, which means that the actual distance of each non-adhesive strip 13N below the horizontal perforation may vary from sheet to sheet.

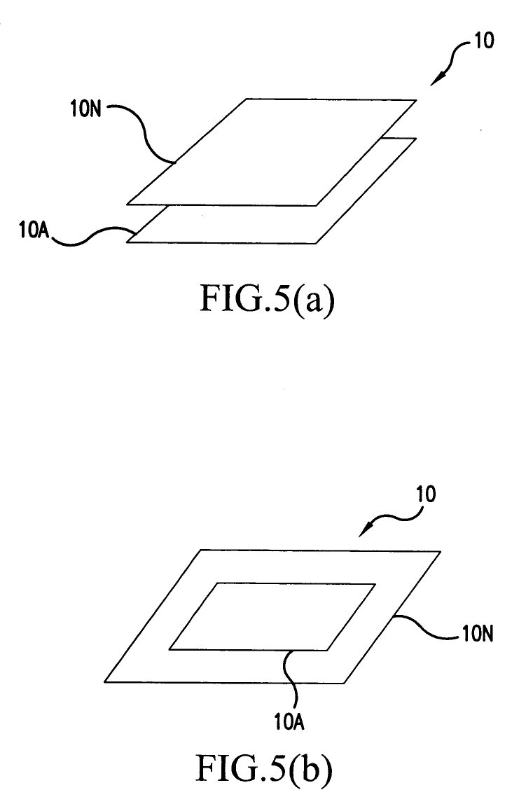

FIGS. 5(a) and (b) show another embodiment with multiple layers, layer 10A being formed of absorbent material, and layer 10N being formed of non-absorbent material. FIG. 5(b) shows the absorbent layer 10A, being smaller than liquid impermeable layer 10N.

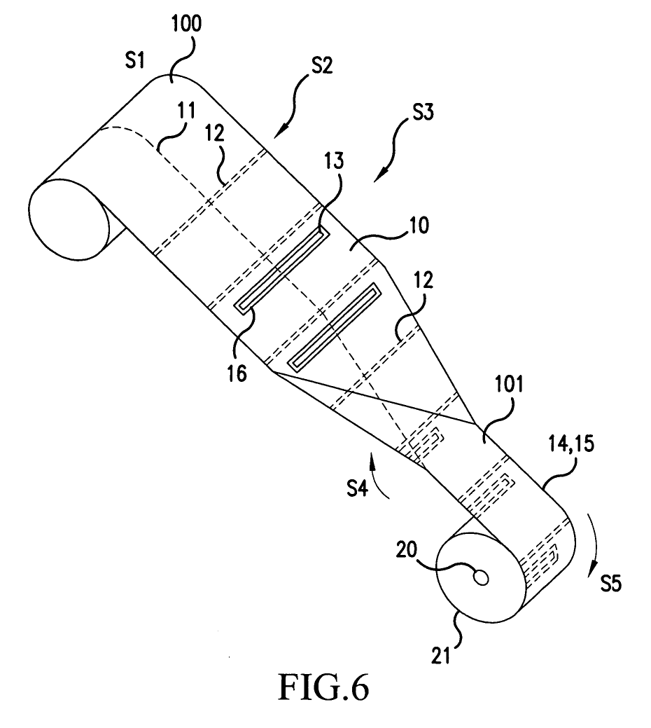

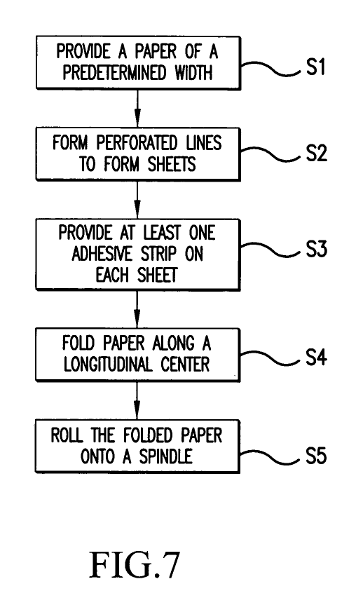

FIGS. 6 and 7 illustrate the primary steps for one method of manufacturing a roll of paper towels having adhesive strips of the present invention. Paper is formed and dried by a known process and is cut into widths to be used in the rolled paper towels. As shown in FIGS. 6 and 7, paper 100 provided in step S1 is perforated in step S2, and a plurality of perforated tear lines 12 are formed, thus forming rectangular sheets 10. In step S3, one or more adhesive strip 13 is attached to each sheet 10. The paper 100 is then fed into the folding operation in step S4 to form folded paper 101. In step S5, the folded paper 101 is rolled onto spindle 20. Based on the number of sheets 10 that are desired on each roll 21, the paper is cut to a predetermined length. The operation to cut the paper 100 to a predetermined length may be accomplished before or after the folded paper 101 is rolled onto the spindle 20.

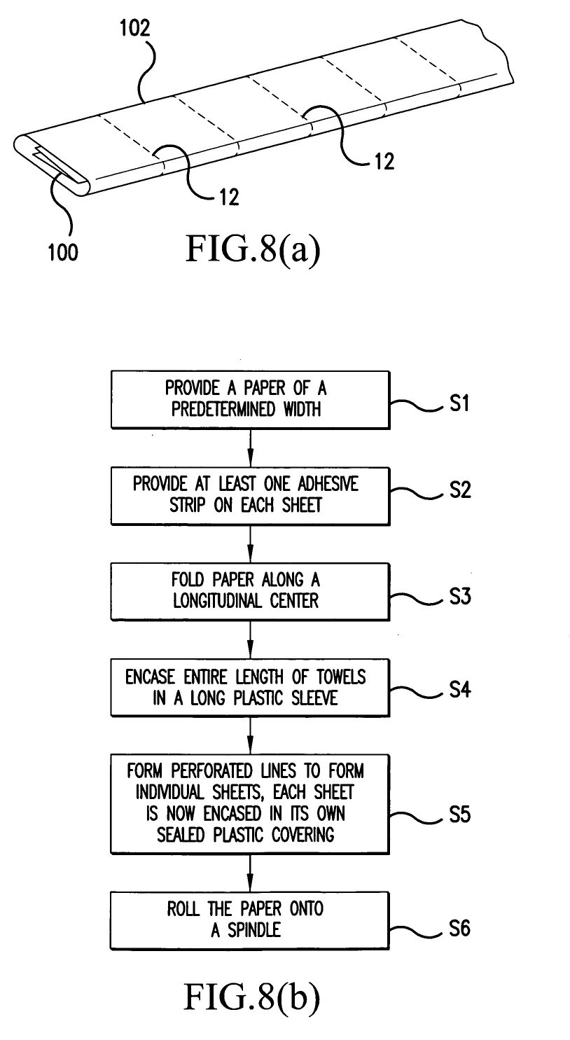

FIG. 8(a) shows still another embodiment in which the length of paper 100 is encased in a sleeve 102 made of non-porous material, such as a plastic film. FIG. 8(b) illustrates a flow chart of the manufacturing operation for this embodiment. In the case where sheets 10 are sterilized, for use in a medical application for example, the sleeve 102 provides a sealed protective covering for each sheet 10. Perforated tear lines 12 are provided on the sleeve 102 so that individual encased sheets 10, together with a section of the sleeve 102 between two tear lines 12, may be easily torn off the roll. The individual sheet 10 may then be removed from the section of the sleeve when needed.

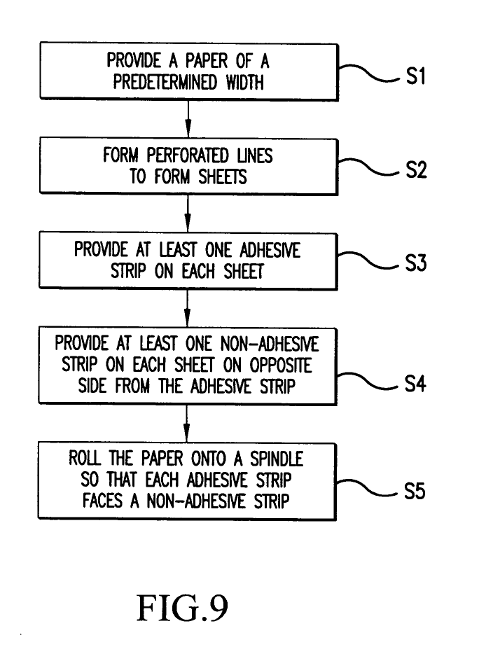

FIG. 9 illustrates the primary steps for a third method of manufacturing a roll of paper towels having adhesive strips of the present invention. Paper is formed and dried by a known process and is cut into widths to be used in the rolled paper towels. As shown in FIG. 9, paper 100 provided in step S1 is perforated in step S2, and a plurality of perforated tear lines 12 are formed, thus forming rectangular sheets 10. In step S3, one or more adhesive strip 13 is attached to one surface of each sheet 10. In step S4, one or more non-adhesive strips is attached to the opposite surface of each sheet 10. In step S5, the paper 100 is rolled onto spindle 20 so that the adhesive strips on one sheet face the non-adhesive strips on the adjoining sheet.

Numerous variations to the above-described embodiments are to be considered within the scope of this invention. For example, the width of the paper may be more or less than 11″, and the paper provided may have one or more plies of the same or different consistency. Adhesive strips may have various shapes, some having designs that are appealing to the eye, and in addition may be located on the sheets in positions which best suit the application for which the towels are used. For example, the paper towels may be formed so that the strip of adhesive on each sheet is placed immediately below the horizontal perforation, making the towels suitable for catching dripping paint; e.g., when painting a vertical surface, the towels can be placed on the flat horizontal surface below, and just up against the vertical surface, so that the towel will catch any paint that drips down. Masking tape for such a use will no longer be necessary.

For the painting example described above, towels formed with two layers (e.g., one absorbent layer 13A, and one non-absorbent layer 13N, as shown in FIGS. 5(a) and (b)) would be particularly useful. Paint dripping onto the absorbent layer 13A would not penetrate through the non-absorbent layer 13N. In this embodiment, the adhesive strip may be placed on the non-absorbent layer.

The paper towels may be formed with any of a variety of antibacterial and disinfectant agents, giving an additional benefit to the towels when used in kitchens and baths. In addition, the paper used for the towels may be sterilized, giving an additional benefit to the towels when used in hospital, emergency care, and nursing home settings.

The non-adhesive borders may be formed of a flexible plastic or other suitable material, and be either clear or have a distinctive color. The sheets may be embossed with instructions, indicating the edges to separate when unfolding the sheets. Further, the sheets, adhesive strips, and non-adhesive borders may be labeled with a trademark to indicate the brand of towels, for instance, “Towel Sticks”™.

The paper towels may be formed so that the towels contain one or more medications (such as medications that treat pain, diseases such as diabetes, or any other health condition). The towels will work so that, when an individual sheet is placed flat against a patient's bare skin, the patient's body will absorb the medicine in the towel. The towel will be formed so that the adhesive strips on the sheet cause the sheet to adhere to the patient's skin until all the medication is fully absorbed by the patient's body. The adhesive strips on the paper towel will be benign and will not harm the skin of the patient, and the individual sheet may be easily removed at any time from the patient's body.

The sheets in the embodiments above are separated by the user from a roll of towels. They may be sold under a doctor's prescription or not, depending on the nature of the medication the towels contain.

As shown in FIGS. 5(a) and (b), the paper towels may be formed with two or more layers so that the top layer 10A or layers will be made of absorbent paper, but the entire bottom layer 10N will always be made of material that is non-absorbent or liquid impermeable, so that liquid will be absorbed by the top layer or layers of the towel (the layers made of paper), but the liquid will not pass through the bottom, non-absorbent layer of the towel. Towels so formed have many possible uses, including the medical application described above. In this case, the medication contained in the absorbent layer of the towel will pass in one direction only; that is, into the skin of the patient and not into the patient's clothing.

These and other variations are not to be regarded as a departure from the spirit and scope of the invention, and all such modifications as would be obvious to one skilled in the art are intended to be included within the scope of the following claims.

1. A roll of paper towels comprising:
a length of paper, the paper having a predetermined width, a plurality of perforated tear lines formed at predetermined intervals and running perpendicular to the length and between two edges of the paper;
a plurality of rectangular sheets being formed between the perforated tear lines;
at least one adhesive strip provided on one surface of each of the rectangular sheets;
a fold formed along a longitudinal centerline of the paper, the edges of the paper being folded together enclosing the at least one adhesive strip and forming a folded paper having double thickness and a width one half of the width of the paper prior to folding; and
a spindle, the folded length of paper being rolled on the spindle,
wherein, upon unrolling of the folded paper, each of the plurality of sheets is separable along the perforated tear lines from an adjoining one of the plurality of rectangular sheets, and capable of being unfolded to expose the at least one adhesive strip.

2. The roll of paper towels according to claim 1, wherein the at least one adhesive strip has a length being less than the width of the paper and has a width being approximately ½″, the adhesive strip being centered on the longitudinal centerline of each of the sheets, so that left and right halves of the of adhesive strip face each other when the paper is folded.

3. The roll of paper towels according to claim 1, wherein the at least one adhesive strip comprises four adhesive strips, a first and a second of the adhesive strips being provided on the longitudinal center line, and a third and a fourth of the adhesive strips being provided symmetrically adjacent to the edges of the paper so as to face each other when the paper is folded along the centerline.

4. The roll of paper towels according to claim 1, wherein the at least one adhesive strip is capable of adhering the sheets to smooth surfaces and rough surfaces and also releasing the sheets therefrom.

5. The roll of paper towels according to claim 1, wherein the at least one adhesive strip is disposed immediately below each one of the perforated tear lines.

6. The roll of paper towels according to claim 1, wherein the paper includes an antibacterial or disinfectant agent.

7. The roll of paper towels according to claim 1, wherein the length of paper is sterilized, and after being folded, the length of paper is encased in a sleeve of non-porous material prior to being rolled on the spindle.

8. The roll of paper towels according to claim 1, wherein the paper is formed with multiple layers of material.

9. The roll of paper towels according to claim 8, wherein the multiple layers of material include at least one layer being an absorbent layer of material, and at least one layer being a liquid impermeable layer of material.

10. The roll of paper towels according to claim 9, wherein the at least one layer of the liquid impermeable material is formed with an opening to expose the at least a portion of the layer of the absorbent material.

11. The roll of paper towels according to claim 9, wherein the at least one layer of the absorbent material is treated with medication.

12. The roll of paper towels according to claim 9, wherein the at least one layer of the absorbent layer of material, and at least one layer of the liquid impermeable layer of material may have different length and width dimensions with respect to each other.

13. A roll of paper towels, comprising:
a length of paper, the paper having a predetermined width, a plurality of perforated tear lines formed at predetermined intervals and running perpendicular to the length and between two edges of the paper;
a plurality of perforated tear lines formed at predetermined intervals and running perpendicular to the length and between two edges of the paper;
a plurality of rectangular sheets being formed between the perforated tear lines;
at least one adhesive strip provided on one surface of each of the rectangular sheets, and at least one non-adhesive strip provided on an opposite surface of each of the rectangular sheets;
the paper being rolled on a spindle so that the at least one adhesive strip on each of the rectangular sheets faces the at least one non-adhesive strip provided on the opposite surface of the adjoining rectangular sheet,
wherein, upon unrolling of the paper, each of the plurality of sheets is separable along the perforated tear lines from the adjoining one of the plurality of rectangular sheets, thereby exposing the at least one adhesive strip.

14. The roll of paper towels according to claim 13, wherein the at least one adhesive strip comprises four adhesive strips, a first and a second of the adhesive strips being provided on the longitudinal center line, and a third and a fourth of the adhesive strips being provided symmetrically adjacent to the edges of the paper.

15. A method of manufacturing a roll of paper towels with sheets having adhesive strips comprising the steps of:
providing a paper having a predetermined length and width;
forming a plurality of perforated tear lines at predetermined intervals and running perpendicular to the length and between two edges of the paper, thereby forming a rectangular sheet between each of the perforated tear lines;
providing at least one adhesive strip on one surface of each of the rectangular sheets;
folding the paper along a longitudinal centerline of the paper, the edges of the paper being folded together enclosing the at least one adhesive strip and forming a folded paper and folded rectangular sheets having double thicknesses and widths one half of the widths prior to folding; and
rolling the folded paper, and the folded rectangular sheets formed thereon, onto a spindle.

16. The method of manufacturing a roll of paper towels with sheets having adhesive strips according to claim 15, further comprising the steps of:
sterilizing the length of paper; and
encasing the length of paper in a sleeve of non-porous material after the folding step and prior to the rolling step.

17. The method of manufacturing a roll of paper towels with sheets having adhesive strips according to claim 15, further comprising the step of cutting the paper to a predetermined length based on the number of the folded sheets that are desired to be rolled onto the spindle.

18. The method of manufacturing a roll of paper towels with sheets having adhesive strips according to claim 15, wherein the at least one adhesive strip comprises four adhesive strips, a first and a second of the adhesive strips being provided on the longitudinal center line, and a third and a fourth of the adhesive strips being provided symmetrically adjacent to the edges of the paper so as to face each other when the paper is folded along the centerline.

19. The method of manufacturing a roll of paper towels with sheets having adhesive strips according to claim 15, wherein the at least one adhesive strip is capable of adhering the sheets to smooth surfaces and rough surfaces and also releasing the sheets therefrom.

20. A method of manufacturing a roll of paper towels with sheets having adhesive strips comprising the steps of:
providing a paper having a predetermined length and width;
forming a plurality of perforated tear lines at predetermined intervals and running perpendicular to the length and between two edges of the paper, thereby forming a rectangular sheet between each of the perforated tear lines;
providing at least one adhesive strip on one surface of each of the rectangular sheets;
providing at least one non-adhesive strip provided on an opposite surface of each of the rectangular sheets;
rolling the paper on a spindle so that the at least one adhesive strip on each of the rectangular sheets faces the at least one non-adhesive strip provided on the opposite surface of the adjoining rectangular sheet,
wherein, upon unrolling of the paper, each of the plurality of sheets is separable along the perforated tear lines from the adjoining one of the plurality of rectangular sheets, thereby exposing the at least one adhesive strip.
